(19) United States
(12) Patent Application Publication
(10) Pub. No.: US 2018/0009707 A1
(43) Pub. Date: Jan. 11, 2018

(54) GLASS SHEET

(71) Applicant: ASAHI GLASS COMPANY, LIMITED, Chiyoda-ku (JP)

(72) Inventors: Takenori Miura, Tokyo (JP); Satoshi Miyasaka, Tokyo (JP); Yasuo Hayashi, Tokyo (JP); Kazuhiko Yamanaka, Tokyo (JP)

(73) Assignee: ASAHI GLASS COMPANY, LIMITED, Chiyoda-ku (JP)

(21) Appl. No.: 15/711,319

(22) Filed: Sep. 21, 2017

Related U.S. Application Data
(63) Continuation of application No. PCT/JP2016/058967, filed on Mar. 22, 2016.

(30) Foreign Application Priority Data
Mar. 25, 2015 (JP) 2015-063309

(51) Int. Cl. C03C 21/00; C03C 23/00; C03C 15/00

(52) U.S. Cl. CPC C03C 21/007; C03C 2203/46; C03C 15/00; C03C 23/0095; C03C 2201/12

(57) ABSTRACT

A glass sheet includes a first main surface and a second main surface opposite to the first main surface in a thickness direction. X represented by the following formula (1) is −0.29<X<0.29: A×Δ¹H/³⁰Si+B×ΔNa₂O+C×ΔSn+D×ΔF=X (1). F₀₋₃ determined according to the following formula (II) is 0.02 or more: F₀₋₃=[average fluorine concentration (wt %) by SIMS at depth of 0 to 3 μm in first main surface]×3 (II).

### TECHNICAL FIELD

The present invention relates to a glass sheet.

### BACKGROUND ART

Recently, in flat panel display devices of a mobile phone, a personal digital assistance (PDA), a personal computer, a television, an in-vehicle navigation display device, etc., a thin sheet-shaped cover glass is arranged on a front side of a display so as to cover a wider region than an image display area and thereby achieve protection and enhanced aesthetic appearance of the display.

Reduction in weight and thickness is required of such a flat panel display device and in turn, a cover glass used for display protection is also required to be thinned.

However, reduction in the thickness of the cover glass poses a problem that the strength decreases and the cover glass itself may be broken by dropping, etc. during use or carrying and cannot fulfill its primary role of protecting the display device.

Accordingly, in a conventional cover glass, a glass produced by a float process (hereinafter, sometimes referred to as float glass) is chemically strengthened so as to form a compressive stress layer in a surface and thereby enhance a scratch resistance of the cover glass.

It has been reported that in the float glass, warpage occurs after chemical strengthening and impairs flatness. The warpage is supposed to occur because a glass surface (hereinafter, sometimes referred to as top surface) not in contact with a molten metal, such as molten tin, during float forming and a glass surface opposite to the top surface and (hereinafter, sometimes referred to as bottom surface) in contact with the molten metal become heterogeneous to produce a difference in chemical strengthening behavior between two surfaces.

The warpage of a float glass becomes large with increasing the degree of chemical strengthening behavior. Accordingly, in the case of setting the surface compressive stress to be higher than before, particularly to be 600 MPa or more, with an attempt to meet the requirement for high scratch resistance, the problem of warpage emerges more prominently.

In order to prevent production of a difference in the degree of chemical strengthening behavior between one surface and another surface of the glass, Patent Document 1 discloses a method for reducing warpage after chemical strengthening by, in, subjecting the glass surface before chemical strengthening to dealkalization and Patent Document 2 discloses subjecting the glass surface before chemical strengthening to a fluorine treatment.

In addition, from the viewpoint of improving the appearance, a measure of subjecting the glass surface to a grinding or polishing treatment, etc. and thereby removing surface flaws produced during glass production is sometimes taken. Above all, the bottom surface of float glass is put into contact with a roller in the production step and is therefore susceptible to surface flaws, compared with the top surface.

### CITATION LIST

### Patent Document

Patent Document 1: International Publication No. 2014/104303

Patent Document 2: International Publication No. 2013/146440

### SUMMARY OF THE INVENTION

### Problems that the Invention is to Solve

However, in the methods described in Patent Documents 1 and 2, at the time of removal of surface flaws, when the glass surface is subjected to a grinding or polishing treatment, a dealkalized layer or fluorinated layer is eliminated, giving rise to a problem that the effect of dealkalization or fluorine treatment is reduced and warpage after chemical strengthening increases.

Accordingly, an object of the present invention is to provide a glass sheet in which warpage after chemical strengthening can be effectively suppressed even when the glass surface is subjected to a grinding or polishing treatment.

### Means for Solving the Problems

The present inventors have found that with respect to water, sodium, tin and fluorine in a glass surface layer, when a content difference between two main surfaces of glass is optimally balanced, the above-described object can be attained. The present invention has been accomplished based on this finding.

That is, the present invention is as follows.

[1] A glass sheet including a first main surface and a second main surface opposite to the first main surface in a thickness direction, wherein X represented by the following formula (1) is −0.29<X<0.29 and F₀₋₃ determined according to the following formula (II) is 0.02 or more.

A×Δ¹H/³⁰Si+B×ΔNa₂O+C×ΔSn+D×ΔF=X (1)

In the formula (1), each parameter has the following meaning.

Δ¹H/³⁰Si: a value of difference obtained by subtracting an average ¹H/³⁰Si count by secondary ion mass spectroscopy (SIMS) at a depth of 3 to 12 μm in the second main surface from an average ¹H/³⁰Si count by SIMS at a depth of 3 to 12 μm in the first main surface.

ΔNa₂O: a value of difference obtained by subtracting an average Na₂O concentration (wt %) by XRF at a depth of 0 to 3 μm in the second main surface from an average Na₂O concentration (wt %) by XRF at a depth of 0 to 3 μm in the first main surface.

ΔSn: a value of difference obtained by subtracting Tin count as an indicator of tin content in a glass by XRF at a depth of 0 to 10 μm in the second main surface from the value of Tin count as an indicator of tin content in a glass by XRF at a depth of 0 to 10 μm in the first main surface.

ΔF: a value of difference obtained by subtracting an average fluorine concentration (wt %) by SIMS×12 at a depth of 0 to 12 μm in the second main surface from an average fluorine concentration (wt %) by SIMS×12 at a depth of 0 to 12 μm in the first main surface.

A: −128.95

B: 1

C: −0.0002428

D: −0.009922

F₀₋₃=[average fluorine concentration (wt %) by SIMS at depth of 0 to 3 μm in first main surface]×3 (II)

[2] The glass sheet according to above [1], wherein a surface layer fluorine ratio represented by the following formula (I) is 0.2 or more and less than 0.9.

surface-layer fluorine ratio=F₀₋₃/F₀₋₃₀ (I)

In the formula (I), F₀₋₃ is determined according to the following formula (II).

F₀₋₃=[average fluorine concentration (wt %) by SIMS at depth of 0 to 3 μm in first main surface]×3 (II)

In formula (I), F₀₋₃₀ is determined according to the following formula (III).

F₀₋₃₀=[average fluorine concentration (wt %) by SIMS at depth of 0 to 30 μm in first main surface]×30 (III)

[3] The glass sheet according to above [1] or [2], which is a glass sheet produced by a float process.
[4] A chemically strengthened glass sheet obtained by chemically strengthening the glass sheet according to any one of above [1] to [3].

### Advantage of the Invention

According to the present invention, warpage after chemical strengthening can be effectively suppressed even when the glass surface is subjected to a grinding or polishing treatment.

### BRIEF DESCRIPTION OF THE DRAWINGS

FIG. 1 is a diagram schematically illustrating a double-flow type injector usable in the present invention.

FIG. 2 is a diagram schematically illustrating a single-flow type injector usable in the present invention.

FIG. 3A is a schematic explanatory diagram of a method for, in the production of a glass sheet by a float process, treating a glass ribbon surface by supplying a gas containing a molecule having a fluorine atom in its structure by means of a beam, and FIG. 3B is an A-A cross-sectional view of FIG. 3A.

The parts (a) to (d) of FIG. 4 each illustrates a cross-sectional view of a beam capable of adjusting the amount of gas by dividing it into three portions in the width direction of a glass ribbon.

FIG. 5A to FIG. 5C each illustrates a typical fluorine concentration profile by SIMS of a fluorine-treated soda lime silica glass.

FIG. 6 illustrates a typical ¹H/³⁰Si profile by SIMS of soda lime silica glass.

### Mode for Carrying Out the Invention

### 1. Glass Sheet

In the present invention, the “glass sheet” encompasses a molten glass formed in a sheet shape and, for example, a so-called glass ribbon in a float bath is also a glass sheet. Warpage of a glass sheet after chemical strengthening occurs due to a difference in the degree of chemical strengthening behavior between one surface and another surface of the glass sheet. Specifically, for example, in the case of a float glass, warpage after chemical strengthening occurs due to a difference in the degree of chemical strengthening behavior between a glass surface (top surface) not in contact with a molten metal (usually tin) and a glass surface (bottom surface) in contact with the molten metal during float forming. Accordingly, a glass sheet produced by a float process is preferred, because the improvement of warpage after chemical strengthening, which is the effect of the present invention, is likely to be exerted.

The glass sheet of the present invention is a glass sheet including a first main surface and a second main surface opposite to the first main surface in a thickness direction, wherein X represented by the following formula (1) satisfies −0.29<X<0.29.

A×Δ¹H/³⁰Si+B×ΔNa₂O+C×ΔSn+D×ΔF=X (1)

In the formula (1), each parameter has the following meaning.

A¹H/³⁰Si: a value of difference obtained by subtracting an average ¹H/³⁰Si count by secondary ion mass spectroscopy (SIMS) at a depth of 3 to 12 μm in the second main surface from an average ¹H/³⁰Si count by SIMS at a depth of 3 to 12 μm in the first main surface.

ΔNa₂O: a value of difference obtained by subtracting an average Na₂O concentration (wt %) by XRF at a depth of 0 to 3 μm in the second main surface from an average Na₂O concentration (wt %) by XRF at a depth of 0 to 3 μm in the first main surface.

ΔSn: a value of difference obtained by subtracting Tin count as an indicator of tin content in a glass by XRF at a depth of 0 to 10 μm in the second main surface from the value of Tin count as an indicator of tin content in a glass by XRF at a depth of 0 to 10 μm in the first main surface.

ΔF: a value of difference obtained by subtracting an average fluorine concentration (wt %) by SIMS×12 (intake fluorine amount) at a depth of 0 to 12 μm in the second main surface from an average fluorine concentration (wt %) by SIMS×12 (intake fluorine amount) at a depth of 0 to 12 μm in the first main surface.

A: −128.95

B: 1

C: −0.0002428

D: −0.009922

In the present description, the first main surface and second main surface of a glass sheet mean one surface and another surface opposite in the thickness direction. In addition, both surfaces (both main surfaces) of a glass sheet indicate both surfaces opposite to each other in the thickness direction. In the case where the glass sheet of the present invention is a glass sheet produced by a float process, it is preferred that the first main surface is the top surface and the second main surface is the bottom surface.

X represented by the formula (1) is a numerical indicator for controlling the warpage amount to fall in an optimal range by comprehensively considering various factors affecting the warpage amount after chemical strengthening, and when X is in the range of −0.29<X<0.29, the warpage amount after chemical strengthening can be effectively reduced. The water amount, sodium amount, tin amount and fluorine amount in the glass surface layer or in a region at a fixed depth from the surface are different between one main surface (first main surface) of the glass sheet and another main surface (second main surface) opposite in the thickness direction, and this is considered to affect the degree of chemical strengthening behavior. As to the water amount, the factor causing the difference is considered to be, for example, a difference in the degree of water desorption from the glass in a float bath. As to the sodium amount, the factor is considered to be, for example, a difference in the degree of SO₂ treatment in a lehr. As to the tin amount, the factor is considered to be, for example, the contact of the second main surface with a tin bath. As to the fluorine amount, the difference is produced, for example, by surface-treating the first main surface.

However, if respective content differences are specified individually, the warpage after chemical strengthening cannot be sufficiently suppressed, and when these content differences are optimally balanced in a comprehensive manner, the warpage after chemical strengthening can be effectively suppressed.

From the viewpoint of preventing a deleterious change in warpage after strengthening due to polishing, X is preferably −0.23<X<0.23, more preferably −0.1<X<0.1.

From the viewpoint of preventing a deleterious change in warpage after strengthening due to polishing, Δ¹H/³⁰Si is preferably from −0.004 to −0.0010, more preferably from −0.0029 to −0.0018.

From the viewpoint of preventing a deleterious change in warpage after strengthening due to polishing, ΔNa₂O is preferably from −0.6 to 0.11, more preferably from −0.2 to 0.1, still more preferably from −0.1 to 0.1.

From the viewpoint of preventing a deleterious change in warpage after strengthening due to polishing, ΔSn is preferably from −1,000 to −400, more preferably from −914 to −512.

From the viewpoint of preventing a deleterious change in warpage after strengthening due to polishing, ΔF is preferably from 0.2 to 2.3, more preferably from 0.5 to 1.6.

In order for X to reside in the range above, it is preferable to control each parameter of Δ¹H/³⁰Si, ΔNa₂O, ΔSn and ΔF.

Control of Δ¹H/³⁰/³⁰Si can be achieved by adjusting the water amount in both main surfaces of glass and includes, for example, a method of changing the forming temperature in a float bath or the ambient water concentration of a float bath.

Control of ΔNa₂O can be achieved by adjusting the Na₂O amount in both main surfaces of glass and includes, for example, a method by dealkalization surface treatment in a float bath or a lehr.

Control of ΔSn can be achieved by adjusting the tin amount in both main surfaces of glass and includes, for example, a method of changing the forming temperature in a float bath or the concentration of hydrogen contained in the atmosphere or treating the first main surface with an Sn-containing gas in a float bath or a lehr.

Control of ΔF can be achieved by adjusting the fluorine amount in both main surfaces of glass and includes, for example, a method of changing the contacting gas concentration at the time of surface treatment of the first main surface in a float bath.

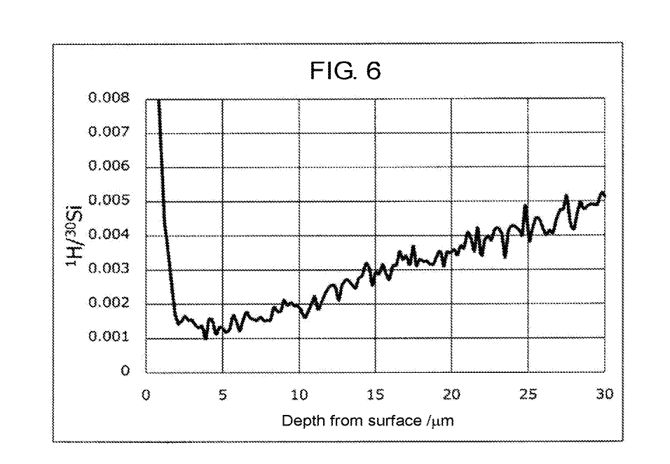

After conducting a measurement of ¹H/³⁰Si profile in the glass with an SIMS apparatus, Δ¹H/³⁰Si is calculated from the profile by the following procedure. FIG. 6 illustrates a typical ¹H/³⁰Si profile by SIMS of soda lime silica glass. Here, the H (hydrogen) element in glass obtained by SIMS is known to be well correlated with the water concentration in the glass, and evaluating the ¹H/³⁰Si profile may be considered to have the same meaning as evaluating the water concentration profile in glass. The average ¹/³⁰Si count intensity is calculated from the average value of ¹H/³⁰Si count intensities by SIMS at a depth of 3 to 12 μm. With respect to values obtained by calculating the average ¹H/³⁰Si count intensity by SIMS at a depth of 3 to 12 μm for both surfaces opposite to each other in the thickness direction of the glass, the value of difference obtained by subtracting the average ¹H/³⁰Si count intensity of the second main surface from the average ¹H/³⁰Si count intensity of the first main surface is the Δ¹H/³⁰Si.

SIMS analysis conditions include, for example, the following conditions. The analysis conditions set forth below are exemplary conditions and should be appropriately changed depending on the measuring apparatus, the sample, etc. The depth on the abscissa of the depth-direction profile obtained by SIMS is determined by measuring the depth of an analysis crater with a stylus type film thickness meter (for example, DEKTAK 150, manufactured by Veeco Instruments Inc.).

### (Analysis Conditions)

Primary ion species: Cs⁺

Primary ion incident angle: 60°

Primary acceleration voltage: 5 kV

More specific analysis conditions include, for example, the following conditions.

### (Analysis Conditions)

Measuring apparatus: a secondary ion mass spectrometry apparatus having a quadrupole mass spectrometer

Primary ion species: Cs⁺

Primary acceleration voltage: 5.0 kV

Primary ion current: 1 μA

Primary ion incident angle (angle from vertical direction of sample surface) 60°

Raster size: 200×200 μm²

Detection area: 40×40 μm²

Secondary ion polarity: minus

Use of electron gun for neutralization: yes

The secondary ion mass spectrometry apparatus having a quadrupole mass spectrometer includes, for example, ADEPT 1010 manufactured by ULVAC-PHI Inc.

The average Na₂O concentration in the glass surface layer can be evaluated by XRF (X-ray Fluorescence Spectrometer) using Na-Kα radiation.

The analysis conditions of the XRF method are as follows. The quantitative determination is performed by a calibration method using an Na₂O standard sample. The measuring apparatus includes ZSX100 manufactured by Rigaku Corporation.

Output: Rh 50 kV-60 mA

Filter: OUT

Attenuator: 1/1

Slit: Std.

Dispersive crystal: RX25

Detector: PC

Peak angle (2θ/deg.): 46.42

Peak measurement time (second): 30

B.G. (2θ/deg.): none

PHA: 100-500

In general, average information of Na₂O contained in a region from the glass surface layer (0 μm) to a depth of about 3 μm is obtained by this method. The value of difference obtained by subtracting the value of average Na₂O concentration (wt %) in the second main surface from the value of average Na₂O concentration (wt %) in the first main surface, which are the values calculated for both surfaces opposite to each other in the thickness direction of the glass by using the method above, is ΔNa₂O.

The tin content in the glass surface layer can be evaluate by XRF using Sn-Lα radiation, and an index value indicating the Sn content obtained is referred to as Tin count.

Output: Rh 50 kV-50 mA

Filter: OUT

Attenuator: 1/1

Slit: Std.

Dispersive crystal: LiF

Detector: PC

Peak angle (2θ/deg.): 126.76

Peak measurement time (second): 10

B.G. (2θ/deg.): 123.55

B.G. measurement time (second): 5

PHA: 115-315

In general, average information of SnO₂ contained in a region from the glass surface layer (0 μm) to a depth of about 10 μm is obtained by this method. The value of difference obtained by subtracting the value of Tin count in the second main surface from the value of Tin count in the first main surface, which are the values calculated for both surfaces opposite to each other in the thickness direction of glass by using the method above, is ΔSn.

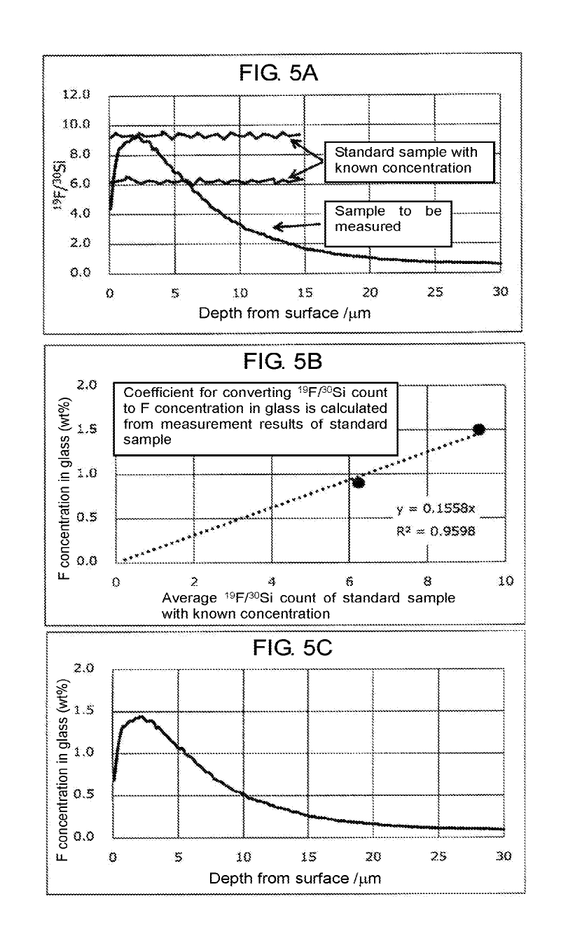

After conducting a measurement of a fluorine concentration profile in the glass with an SIMS apparatus, the average fluorine concentration is calculated from the profile according to the following procedure (a1) to (a3). FIG. 5A to FIG. 5C depict a typical fluorine concentration profile by SIMS of a fluorine-treated soda lime silica glass.

(a1) The fluorine concentration profiles by SIMS of a standard sample with a known concentration and a sample to be measured are measured [FIG. 5A].

(a2) A calibration curve is prepared from the measurement results of the standard sample, and a coefficient for converting the ¹⁹F/³⁰Si count to a fluorine concentration (wt %) is calculated [FIG. 5B].

(a3) The intake fluorine concentration (wt %·μm) of the sample to be measured is determined from the coefficient calculated in the step (a2). For example, the intake fluorine amount (wt %) by SIMS at a depth of 0 to 3 μm is a value obtained by calculating an average value of the fluorine concentration at a depth of 0 to 3 μm and multiplying the average value by a depth of 3 μm [FIG. 5C].

The intake fluorine amount (wt %·μm) at a depth of 0 to 12 μm is a value obtained by calculating an average value of the fluorine concentration by SIMS at a depth of 0 to 12 μm and multiplying the average value by a depth of 12 μm.

In general, average information of F contained in the region from the glass surface layer (0 μm) to a depth of 12 μm is obtained by this method. The value of difference obtained by subtracting the value of intake fluorine amount in the second main surface from the value of intake fluorine amount in the first main surface, which are the values calculated for both surfaces facing each other in the thickness direction of glass by using the method above, is ΔF.

The intake fluorine amount (wt %·μm) by SIMS at a depth of 0 to 30 μm can also be determined in the same manner.

In the glass sheet of the present invention, F₀₋₃ is 0.02 or more, preferably 0.05 or more, more preferably 0.1 or more. F₀₋₃ is determined according to the following formula (II) and represents the amount of fluorine present at a depth of 0 to 3 μm in the first main surface. When F₀₋₃ is in the range above, the effect of improving warpage after strengthening is advantageously expected. From the viewpoint of avoiding excessive improvement of warpage after strengthening, F₀₋₃ is preferably less than 1.14, more preferably less than 1.00.

F₀₋₃=[average fluorine concentration (wt %) by secondary ion mass spectroscopy (SIMS) at depth of 0 to 3 μm in first main surface]×3 (II)

The average fluorine concentration can be determined by the method above.

In the glass sheet according to the present invention, furthermore, the surface layer fluorine ratio represented by the following formula (I) is preferably 0.2 or more and less than 0.9.

surface layer fluorine ratio=F₀₋₃/F₀₋₃₀ (I)

In formula (I), F₀₋₃ is determined according to the following formula (II).

F₀₋₃=[average fluorine concentration (wt %) by secondary ion mass spectroscopy (SIMS) at depth of 0 to 3 μm in first main surface]×3 (II)

In formula (I), F₀₋₃₀ is determined according to the following formula (III).

F₀₋₃₀=[average fluorine concentration (wt %) by SIMS at depth of 0 to 30 μm in first main surface]×30 (III)

The surface-layer fluorine ratio represented by formula (I) is a parameter specifying the proper fluorine concentration distribution in the thickness direction for the improvement of warpage. The warpage by chemical strengthening of glass is attributable to a difference in the degree of chemical strengthening behavior between two main surfaces of the glass. Due to the presence of fluorine in the glass surface layer, warpage by chemical strengthening of the glass is improved by various factors, and in consideration of the penetration depth from the main surface, the above-described parameter is set to specify the concentration distribution of fluorine present in glass. The average fluorine concentration can be determined by the method above.

By setting the surface-layer fluorine ratio to be 0.2 or more, warpage of glass after chemical strengthening can be effectively suppressed. The surface-layer fluorine ratio is preferably 0.2 or more, more preferably 0.4 or more.

By setting the surface-layer fluorine ratio to be less than 0.9, a deleterious change in warpage due to polishing can be avoided. The surface-layer fluorine ratio is preferably 0.6 or less, more preferably 0.5 or less. In particular, it is more preferred that the surface-layer fluorine ratio is 0.5 or less, because the following effect (1) is remarkably brought out. (1) When the glass is subjected to a fluorine treatment and then to a polishing or etching treatment, fluorine in the glass surface decreases, and the effect of fluorine treatment of glass to suppress warpage after chemical strengthening is reduced. The penetration depth of fluorine into glass is increased by applying a fluorine treatment to give a surface-layer fluorine ratio of 0.6 or less, particularly 0.5 or less, whereby even when the glass is subjected to polishing or etching before chemical strengthening, the effect of a fluorine treatment to suppress the warpage of the glass after chemical strengthening can be sufficiently ensured.

The method for controlling the surface-layer fluorine ratio to fall in the range above includes a method where assuming that the glass transition temperature of a glass sheet is Tg, the surface temperature of the glass sheet is set to be preferably (Tg+230° C.) or more, more preferably (Tg+300° C.) or more at the time of treating the surface of the glass sheet by supplying a gas or liquid containing a molecule having a fluorine atom in its structure (hereinafter, sometimes referred to as a fluorine-containing fluid) to the surface of the glass sheet.

In addition, the method for controlling the surface-layer fluorine ratio to 0.6 or less includes, for example, a method of prolonging the fluorine treatment time, and a method of subjecting the glass to a fluorine treatment and then again applying a heat treatment to bring fluorine in the surface to diffuse into the inside of the glass.

The secondary ion intensity I_{M1} of an isotope M₁ of an element M in SIMS is proportional to primary ion intensity Iₚ, sputtering rate Y of a matrix, concentration C_{M} (ratio relative to total concentration) of the element M, existence probability α₁ of the isotope M₁, secondary ionization rate β_{M} of the element M, and permeation efficiency η (including detection efficiency of a detector) of a mass spectrometer.

I_{M1}=A·Iₚ·Y·C_{M}·α₁·β_{M}·η (formula w)

Here, A is a ratio of a detection area of secondary ion to a scanning range of primary ion beam. In general, since it is difficult to determine η of the apparatus, an absolute value of β_{M} cannot be determined. Accordingly, η is deleted by using, as a reference element, a main component element, etc. in the same sample and taking a ratio to (formula w).

Here, in the case where the reference element is denoted by R and an isotope thereof is denoted by Rⱼ, (formula x) is established.

I_{M1}/I_{Rj}−(C_{M}·α₁·β_{M})/(C_{R}·αⱼ·β_{R})−C_{M}/K (formula x)

In the formula above, K is a relative sensitivity factor of the element M with respect to the element R.

K=(C_{R}·αⱼ·β_{R})/(α₁·β_{M}) (formula y)

In this case, the concentration of the element M is determined according to (formula z).

C_{M}=K·I_{M1}/I_{Rj} (formula z)

In the present invention, H (hydrogen) or F (fluorine) corresponds to Mi, and Si corresponds to Rⱼ. According to (formula x), the intensity ratio (H/Si) or (F/Si) between two elements is equal to the value obtained by dividing the water concentration or fluorine concentration C_{M} in the glass by K. That is, H/Si or F/Si is a direct index of a water concentration or fluorine concentration in the glass.

### 2. Production Method of Glass Sheet

In the present invention, the method for forming molten glass into a plate-shaped glass sheet is not particularly limited, and glass having any composition may be used as long as the glass has a composition capable of being strengthened by a chemical strengthening treatment. For example, various raw materials are compounded in appropriate amounts and then heated and melted. The melt is then homogenized by refining, stirring, etc. and formed into a sheet shape by a well-known method such as float process, down-draw process (e.g., fusion process) or press process, and after annealing, the obtained sheet is cut into a desired size and subjected to polishing to produce the glass sheet. Of these production methods, glass produced by a float process is particularly preferred, because the effect of the present invention, i.e., improvement of warpage after chemical strengthening, is readily exerted.

Examples of the glass sheet for use in the present invention specifically includes, for example, a glass sheet composed typically of soda lime silicate glass, aluminosilicate glass, borate glass, lithium aluminosilicate glass, borosilicate glass, etc.

Among these, a glass having a composition containing Al is preferred. When an alkali is present together, Al is tetra-coordinated and as with Si, participates in the formation of a network that works out to a skeleton of glass. When the proportion of tetra-coordinated Al is increased, movement of an alkali ion is facilitated, and ion exchange readily proceeds at the time of chemical strengthening treatment.

A thickness of the glass sheet is not particularly limited and is, for example, 2 mm, 0.8 mm, 0.7 mm, or 0.4 mm, etc. but in order to effectively perform the chemical strengthening treatment described later, usually, the thickness is preferably 5 mm or less, more preferably 3 mm or less, still more preferably 1.5 mm or less, yet still more preferably 0.8 mm or less.

As for the warpage amount after chemical strengthening of a glass sheet having a thickness of 0.7 mm, from the viewpoint of allowing a final product to exhibit waterproof performance or avoiding yield reduction in the production step, it is usually required that when a 90 mm-square glass sheet is formed, the warpage amount is within ±40 μm. Here, a positive value is assigned when a central portion is higher than a periphery at the time of facing up the first main surface (top surface), and a negative value is assigned when a central portion is higher than a periphery at the time of facing up the second main surface (bottom surface). In the case of a 90 mm-square glass sheet having CS of 700 MPa and DOL of 11 μm, the warpage amount after chemical strengthening is about 130 μm. On the other hand, the warpage amount of a glass sheet after chemical strengthening is inversely proportional to the square of sheet thickness and when the thickness of the glass sheet is 2.0 mm, since the warpage amount becomes about 16 μm, there is substantially no problem with warpage. Accordingly, if the thickness of the glass sheet is less than 2 mm, typically 1.5 mm or less, a problem may arise with warpage after chemical strengthening.

As for the composition of the glass sheet of the present invention, examples of a glass include a glass containing, as a composition represented by mass %, from 60 to 75% of SiO₂, from 0.1 to 12% of Al₂O₃, from 10 to 20% of Li₂O+Na₂O+K₂O, from 2 to 13% of MgO, from 0 to 10% of CaO, from 0 to 3% of SrO, from 0 to 3% of BaO, and from 0 to 4% of ZrO₂, but the composition is not particularly limited. More specifically, examples of the glass composition include the following glass compositions. Here, for example, the phrase “containing from 0 to 10% of CaO” means that CaO is not essential and may be contained up to 10%.

(i) A glass containing, as a composition represented by mass %, from 65 to 74% of SiO₂, from 1 to 9% of Al₂O₃, from 11 to 17% of Na₂O, from 0 to 2% of K₂O, from 3 to 6% of MgO, and from 5 to 9% of CaO.

(ii) A glass containing, as a composition represented by mass %, from 65 to 74% of SiO₂, from 1 to 9% of Al₂O₃, from 12 to 18% of Na₂O, from 0 to 4% of K₂O, from 6 to 12% of MgO, from 0 to 6% of CaO, and from 0 to 4% of ZrO₂.

(iii) A glass containing, as a composition represented by mass %, from 60 to 72% of SiO₂, from 4.4 to 12% of Al₂O₃, from 13 to 19% of Na₂O, from 0 to 5% of K₂O, from 2 to 13% of MgO, and from 0 to 10% of CaO, and from 0 to 4% of ZrO₂.

The glass sheet of the present invention can be produced using the glass above by appropriately combining various surface treatments described below, such as dealkalization treatment, fluorine treatment, and dealkalization treatment in annealing region (lehr).

### (Dealkalization Treatment)

The dealkalization treatment of glass includes, for example, a method of forming a diffusion-suppressing film containing no alkaline component by using a deposition method such as dip coating method and CVD method, a method of treating glass with a liquid or gas causing an ion exchange reaction with an alkaline component in the glass (JP-T-7-507762 (the term “JP-T” as used herein means a published Japanese translation of a PCT patent application)), a method utilizing ion migration under an action of an electric field (JP-A-62-230653), and a method of bringing silicate glass containing an alkaline component into contact with water (H₂O) in a liquid state at 120° C. or more (JP-A-11-171599)

Examples of the liquid or gas causing an ion exchange reaction with an alkaline component in glass include, for example, a fluorine-containing fluid, a gas or liquid of sulfur or its compound or chloride, an acid, and a nitride.

Examples of the fluorine-containing fluid includes, for example, hydrogen fluoride (HF), Freon (e.g., chlorofluorocarbon, fluorocarbon, hydrochlorofluorocarbon, hydrofluorocarbon, halon), hydrofluoric acid, fluorine simple substance, trifluoroacetic acid, carbon tetrafluoride, silicon tetrafluoride, phosphorus pentafluoride, phosphorus trifluoride, boron trifluoride, nitrogen trifluoride, and chlorine trifluoride.

Examples of the gas or liquid of sulfur or its compound or chloride includes, for example, sulfurous acid, sulfuric acid, peroxomonosulfuric acid, thiosulfuric acid, dithionous acid, disulfuric acid, peroxodisulfuric acid, polythionic acid, hydrogen sulfide, sulfur dioxide, and sulfur trioxide. Examples of the acid include hydrogen chloride, carbonic acid, boric acid, lactic acid, etc. Examples of the nitride include nitric acid, nitrogen monoxide, nitrogen dioxide, nitrous oxide, etc. These are not limited to a gas or a liquid.

Among these, hydrogen chloride, hydrogen fluoride, Freon, or hydrofluoric acid is preferred in view of high reactivity with the glass sheet surface. Of these gases, two or more kinds thereof may be mixed and used, and a mixture (mixed fluid) of two or more kinds of acids is more preferred, because the dealkalization amount becomes large.

Examples of the mixed fluid include, for example, a mixture of HCl and HF, a mixture of SO₃ and HF, and a mixture of CO₂ and HF. A fluorine simple substance is preferably not used in a float bath, because its oxidizing power is too strong.

In the case of using a liquid, the liquid may be directly supplied to the glass sheet surface, for example, by spray coating, or the liquid may be vaporized and then supplied to the glass sheet surface. The liquid may be diluted with another liquid or gas, if desired.

The liquid or gas causing an ion exchange reaction with an alkaline component in glass may contain a liquid or gas other than the liquid or gas, and the liquid or gas contained is preferably a liquid or gas incapable of reacting, at ordinary temperature, with the liquid or gas causing an ion exchange reaction with an alkaline component in glass.

Examples of the liquid or gas above include, for example, N₂, air, H₂, O₂, Ne, Xe, CO₂, Ar, He, and Kr but is not limited to those. In addition, two or more kinds thereof may be mixed and used.

As a carrier gas for the gas causing an ion exchange reaction with an alkaline component in glass, an inert gas such as N₂ or argon is preferably used. The gas containing a molecule having a fluorine atom in its structure may further contain SO₂. SO₂ is used at the time of successively producing a glass sheet by a float process, etc. and has a function of preventing generation of a flaw in the glass when a conveying roller is put contact with the glass sheet in an annealing zone. In addition, the gas may contain a gas that is decomposed at a high temperature.

Furthermore, the liquid or gas causing an ion exchange reaction with an alkaline component in glass may contain water vapor or water. Water vapor may be taken out by bubbling heated water with an inert gas such as nitrogen, helium, argon or carbon dioxide. In the case of requiring a large amount of water vapor, it is also possible to adopt a method where water is fed to a vaporizer and is directly vaporized. In the following, the present invention is described by taking, as an example, a case where an HF gas is used as the liquid or gas causing an ion exchange reaction with an alkaline component in glass.

### (Fluorine Treatment)

As to the method for fluorine treatment, a surface treatment is performed by bringing a fluorine-containing fluid into contact with at least one surface of a glass sheet or glass ribbon. In the case of performing a surface treatment by bringing a fluorine-containing fluid into contact with at least one surface of the glass ribbon, the glass ribbon temperature is preferably 650° C. or more. By setting the temperature to be 650° C. or more, the warpage amount of glass after chemical strengthening can be reduced while suppressing generation of the later-described concave part.

Examples of the fluorine-containing fluid include, for example, hydrogen fluoride (HF), Freon (e.g., chlorofluorocarbon, fluorocarbon, hydrochlorofluorocarbon, hydrofluorocarbon, halon), hydrofluoric acid, fluorine simple substance, trifluoroacetic acid, carbon tetrafluoride, silicon tetrafluoride, phosphorus pentafluoride, phosphorus trifluoride, boron trifluoride, nitrogen trifluoride, and chlorine trifluoride but is not limited to these gases or liquids.

Of these, hydrogen fluoride, Freon or hydrofluoric acid is preferred in view of high reactivity with the glass sheet surface. In addition, two or more kinds of these gases may be mixed and used. A fluorine simple substance is preferably not used in a float bath, because its oxidizing power is too strong.

In the case of using a liquid, the liquid may be directly supplied to the glass sheet surface, for example, by spray coating, or the liquid may be vaporized and then supplied to the glass sheet surface. The liquid may be diluted with another liquid or gas, if desired.

The fluorine-containing fluid may contain a liquid or gas other than the liquid or gas above, and the liquid or gas contained is preferably a liquid or gas incapable of reacting, at ordinary temperature, with the molecule having a fluorine atom.

Examples of the liquid or gas above include, for example, N₂, air, H₂, O₂, Ne, Xe, CO₂, Ar, He, and Kr but is not limited to those. Of these gases, two or more kinds thereof may be mixed and used.

As a carrier gas for the gas containing a molecule having a fluorine atom in its structure, an inert gas such as N₂ or argon is preferably used. The gas containing a molecule having a fluorine atom in its structure may further contain SO₂. SO₂ is used at the time of successively producing a glass sheet by a float process, etc. and has a function of preventing generation of a flaw in the glass when a conveying roller is put contact with the glass sheet in an annealing zone. The gas may contain a gas that is decomposed at a high temperature.

Furthermore, the fluorine-containing fluid may contain water vapor or water. Water vapor may be taken out by bubbling heated water with an inert gas such as nitrogen, helium, argon or carbon dioxide. In the case of requiring a large amount of water vapor, it is also possible to adopt a method where water is fed to a vaporizer and is directly vaporized. In the following, the present invention is described by taking, as an example, a case where an HF gas is used as the fluorine-containing fluid.

(Dealkalization Treatment in Annealing Region (lehr))

At the time of float formation, sulfur dioxide or sulfur trioxide is sometimes sprayed from the surface in contact with molten metal (second main surface, bottom surface) for the purpose of flaw prevention during conveyance in the annealing region (lehr). Such a sulfur compound reacts with an alkaline component in the glass to generate, for example, a solid such as Na₂SO₄, and a gap is thereby formed between the glass and the conveying roller, as a result, dealkalization subsidiarily occurs on the bottom surface side. In order to adjust the dealkalization on the surface not in contact with molten metal (first main surface, top surface), a treatment of spraying sulfur dioxide or sulfur trioxide also from the top surface side is performed. The spraying treatment is performed on the upstream side in the annealing region and, for example, the glass temperature is preferably from 400 to 600° C.

Each of sulfur dioxide and sulfur trioxide may be sprayed alone or may be sprayed after mixing it with air as a diluent gas. In the following, the present invention is described by taking, as an example, a case of spraying sulfur trioxide (SO₃).

### (Float Process)

As a specific example of the method for forming molten glass into a plate-shaped glass sheet in the present invention, a float process is described in detail below. In the float process, a glass sheet is produced using a glass production apparatus including a melting furnace for melting raw materials of a glass, a float bath for floating the molten glass on a molten metal (e.g., tin) to form a glass ribbon, and an annealing furnace for annealing the glass ribbon.

At the time of forming a glass on a molten metal (tin) bath, the glass sheet being conveyed on the molten metal bath may be subjected to the above-described dealkalization treatment or fluorine treatment from the side not in contact with the metal surface. In the annealing region subsequent to the molten metal (tin) bath, the glass sheet is conveyed by a roller.

Here, the annealing region encompasses not only the inside of the annealing furnace but also, in the float bath, a portion through which the glass sheet is passed after discharged from the molten metal (tin) bath until conveyed into the annealing furnace. In the annealing region, the above-described dealkalization treatment in the annealing region may be performed from the side not in contact with molten metal (tin).

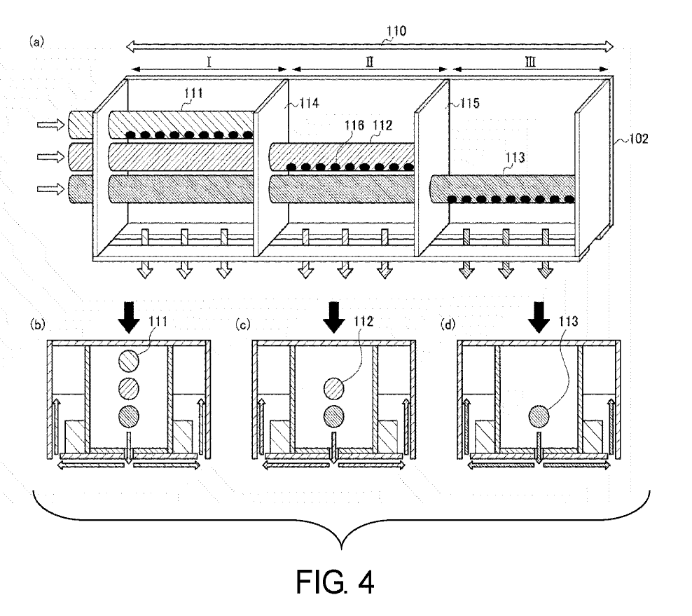

FIG. 3A illustrates a schematic explanatory view of a method of, in the production of a glass sheet by a float process, performing a dealkalization treatment or fluorine treatment within a float bath.

In the float bath for floating the molten glass on a molten metal (e.g., tin) to form a glass ribbon 101, an HF gas is sprayed onto the glass ribbon 101 with a beam 102 inserted into the float bath. As illustrated in FIG. 3A, the HF gas is preferably sprayed onto the glass ribbon 101 from the side where the glass ribbon 101 is not in contact with the molten metal surface. An arrow Ya indicates a direction in which the glass ribbon 101 flows in the float bath.

The position for spraying the HF gas onto the glass ribbon 101 with the beam 102 is preferably a position where, in the case where the glass transition point is 550° C. or more, the temperature of the glass ribbon 101 is from 600 to 970° C., more preferably a position where the temperature is from 700 ° C. to 950° C., still more preferably a position where the temperature is from 750 to 950° C. The position of the beam 102 may be upstream or downstream of a radiation gate 103. The amount of the HF gas sprayed onto the glass ribbon 101 is preferably, in terms of HF, from 1×10⁻⁶ to 5×10⁻⁴ mol/1 cm² of glass ribbon.

FIG. 3B illustrates an A-A cross-sectional view of FIG. 3A. The HF gas sprayed onto the glass ribbon 101 from the direction of Y1 by the beam 102 flows in from “IN” and flows out from the direction of “OUT”. That is, the gas moves in the directions of arrows Y4 and Y5 and is exposed to the glass ribbon 101. The HF gas having moved in the arrow Y4 direction flows out from the arrow Y2 direction, and the HF gas having moved in the arrow Y5 direction flows out from the arrow Y3 direction.

The warpage amount of the glass sheet after chemical strengthening may vary depending on the position in the width direction 101 of the glass ribbon, and in such a case, the amount of the HF gas is preferably adjusted. More specifically, it is preferred that the amount of the HF gas sprayed is increased at the position producing a large warpage amount and the amount of the HF gas sprayed is decreased at the position producing a small warpage amount.

In the case where the warpage amount of the glass sheet after chemical strengthening varies depending on the position of the glass ribbon 101, the warpage amount may be adjusted in the width direction of the glass ribbon 101 by configuring the structure of the beam 102 as a structure enabling the amount of the HF gas to be adjusted in the width direction of the glass ribbon 101.

As a specific example thereof, the part (a) of FIG. 4 illustrates a cross-sectional view of the beam 102 in which the amount of the HF gas is adjusted by dividing it into three portions I to Ill in the width direction 110 of the glass ribbon 101. The gas systems 111 to 113 are separated by partition walls 114 and 115, and the HF gas is flowed out from respective gas blowing holes 116 and sprayed onto the glass.

The arrows in the part (a) of FIG. 4 indicate the flow of HF gas. The arrows in the part (b) of FIG. 4 indicate the flow of the HF gas in the gas system 111. The arrows in the part (c) of FIG. 4 indicate the flow of the HF gas in the gas system 112. The arrows in the part (d) of FIG. 4 indicate the flow of the HF gas in the gas system 113.

The method for supplying the HF gas to the glass surface includes, for example, a method using an injector, and a method using an introduction tube.

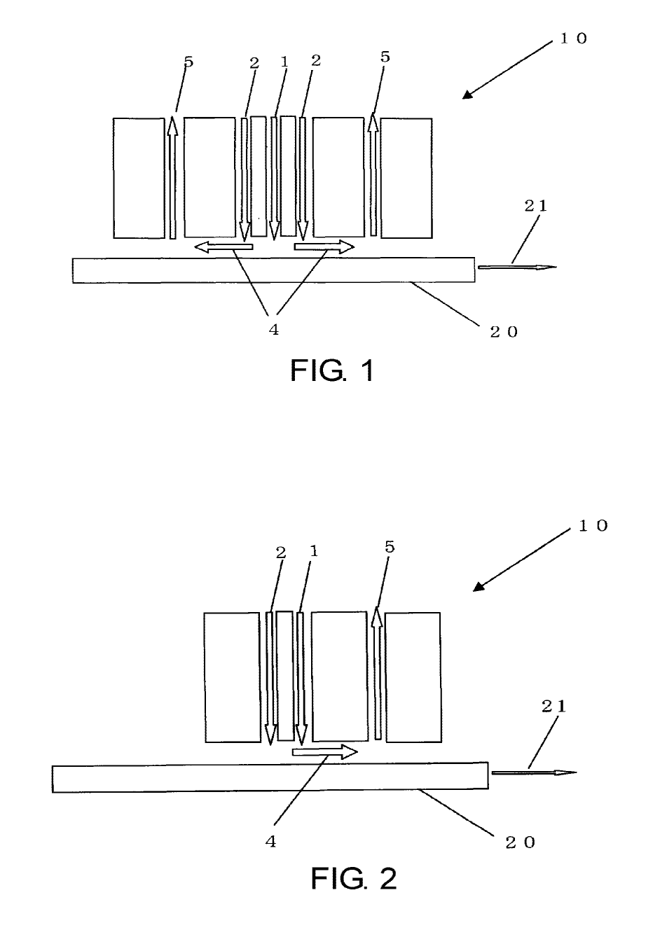

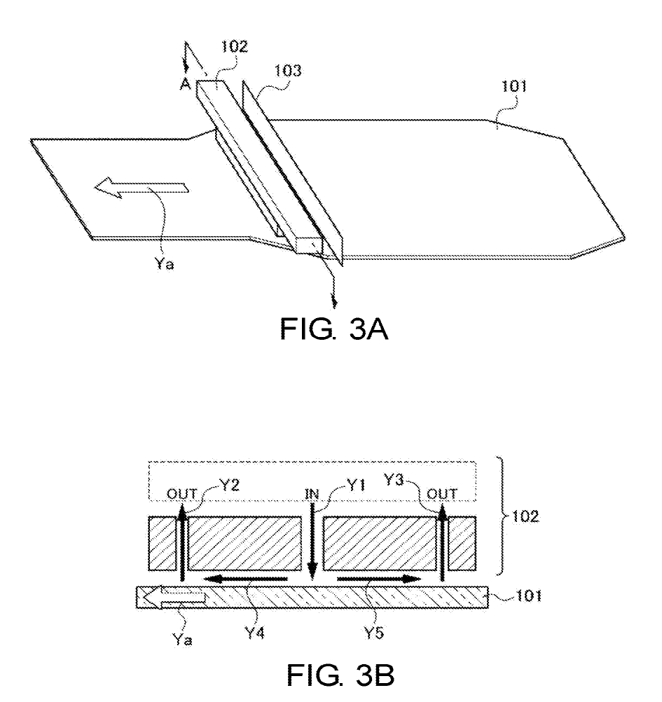

Each of FIG. 1 and FIG. 2 illustrates a schematic view of an injector usable in the present invention. FIG. 1 is a view schematically illustrating a double-flow type injector, and FIG. 2 is a view schematically illustrating a single-flow type injector.

The HF gas is injected toward a glass sheet 20 from a center slit 1 and an outer slit 2, allowed to flow through a channel 4 on the glass sheet 20, and discharged from a discharge slit 5. Here, in FIGS. 1 and 2, the symbol 21 is a direction in which the glass sheet 20 flows, and the direction is parallel to the channel 4.

In the case where the “liquid or gas causing an ion exchange reaction with an alkaline component in glass” or “fluorine-containing fluid”, which is supplied from the injector, is a gas, a distance between a gas injection port of the injector and a glass sheet is preferably 50 mm or less.

When the distance is 50 mm or less, the gas can be prevented from diffusing into the air and in turn, a sufficient amount of gas can be allowed to reach the glass sheet with respect to the desired amount of gas. On the other hand, if the distance to a glass sheet is too short, for example, at the time of online treatment of a glass sheet produced by a float process, there is a risk that the glass sheet comes into contact with the injector due to fluctuation of the glass ribbon.

In the case where the “liquid or gas causing an ion exchange reaction with an alkaline component in glass” or “fluorine-containing fluid”, which is supplied from the injector, is a liquid, a distance between the liquid injection port of the injector and a glass sheet is not particularly limited, and it may be sufficient if these are arranged so that the glass sheet can be uniformly treated.

The injector may be used in any mode, such as double-flow or single-flow mode, and the glass sheet surface may also be treated by arranging two or more injectors in series in the flow direction of glass sheet. The double-flow injector is an injector where, as illustrated in FIG. 1, the flow of HF gas from injection to discharge is split equally into a forward direction and a backward direction relative to the moving direction of glass sheet. The single-flow injector is an injector where, as illustrated in FIG. 2, the flow of HF gas from injection to discharge is fixed to either a forward direction or a backward direction relative to the moving direction of the glass sheet. In the case of using a single-flow injector, the flow of the HF gas above a glass sheet and the moving direction of the glass sheet are preferably identical in view of gas flow stability.

In addition, a supply port for the HF gas and a discharge port for unreacted HF gas and a gas produced by a reaction with the glass sheet or a gas produced by a reaction of two or more kinds of gases out of the HF gas are preferably arranged on the same side of the surface of the glass sheet.

At the time of performing dealkalization treatment by spraying SO₃ onto the surface of a glass sheet being conveyed, in the case where, for example, the glass sheet is flowing on a conveyor, the fluid may be supplied from the side not in contact with the conveyor or may be supplied from the side in contact with the conveyor by using, as a conveyor belt, a mesh material with which a part of the glass sheet is not covered, such as mesh belt.

SO₃ may be sprayed from the side in contact with the conveyor to treat the glass sheet surface, by arranging two or more conveyors in series and disposing an injector between adjacent conveyors. In the case where the glass sheet is flowing on a roller, while spraying SO₃ from the side not in contact with the roller, SO₃ may be sprayed, on the side in contact with the roller, through a space between adjacent rollers.

The same gas or different gasses may be sprayed from both sides of a glass sheet. For example, a dealkalization treatment of the glass sheet may be performed by spraying the gas from both sides, i.e., the side not in contact with the roller and the side in contact with the roller. For example, in the case of spraying the gas from both sides in the annealing region, relative to the glass that is being successively conveyed, injectors may be arranged to face each other across the glass sheet to spray the gas from both sides, i.e., the side not in contact with the roller and the side in contact with the roller.

The injector disposed on the side in contact with the roller and the injector disposed on the side not in contact with the roller may be arranged at different positions in the flow direction of glass sheet. In the case of arranging the injectors at different positions, any injector may be arranged upstream or downstream in the flow direction of glass sheet.

It is widely known that a glass sheet with a transparent conductive film is produced online by combining a glass production technique by a float process with a CVD technique. In this case, it is known that with respect to both of the transparent conductive film and its base film, a film is deposited on a glass sheet by supplying a gas from the surface not in contact with tin or from the surface not in contact with the roller to deposit.

For example, in producing a transparent conductive film-attached glass sheet by online CVD, the glass sheet surface may be treated by arranging an injector at the surface in contact with the roller and supplying a liquid or gas causing an ion exchange reaction with an alkaline component in glass, to the glass sheet from the injector.

In the present invention, in the case of performing a dealkalization treatment in a lehr, at the time when a liquid or gas causing an ion exchange reaction with an alkaline component in glass is supplied to the surface of a glass sheet that is being conveyed and a dealkalization treatment of the surface is thereby performed, a surface temperature of the glass sheet is a temperature on the upstream side within the annealing region and is preferably, for example, from 400 to 600° C.

Assuming that the glass transition temperature of the glass sheet is Tg, the surface temperature of the glass sheet when performing a dealkalization treatment or a fluorine treatment in a float bath is preferably (Tg+230° C.) or more, more preferably (Tg+300° C.) or more.

As for a pressure of the glass sheet surface when supplying the HF gas to the glass sheet surface within a float bath, an atmosphere at a pressure ranging from atmospheric pressure−100 Pa to atmospheric pressure+100 Pa is preferred, and an atmosphere at a pressure ranging from atmospheric pressure−50 Pa to atmospheric pressure+50 Pa is more preferred.

In treating the glass sheet with HF gas, the HF gas flow rate is preferably higher, because the warpage improvement effect at the time of chemical strengthening treatment is greater, and when the total gas flow rate is the same, as the HF concentration is higher, the warpage improvement effect at the time of chemical strengthening treatment is greater.

In the case where both a total gas flow rate and a HF gas flow rate are the same, as the time for treating a glass sheet is longer, the warpage improvement effect at the time of chemical strengthening treatment is greater. Even in an equipment where the total gas flow rate or the HF gas flow rate cannot be successfully controlled, the warpage after chemical strengthening can be improved by appropriately controlling the conveying speed of a glass sheet.

### 3. Chemical Strengthening

Chemical strengthening is a treatment where an alkali metal ion (typically, Li ion or Na ion) with a small ion radius in the glass surface is replaced by an alkali metal ion (typically, K ion) with a larger ion radius through ion exchange at a temperature not more than the glass transition point and a compressive stress layer is thereby formed in the glass surface. The chemical strengthening treatment may be performed by a conventionally known method.

The chemically strengthened glass sheet of the present invention is a glass sheet in which warpage after chemical strengthening is improved. The amount of change in warpage (warpage variation) of a glass sheet after chemical strengthening relative to the glass sheet before chemical strengthening can be measured with a three-dimensional shape measurement instrument (for example, manufactured by NIDEK Co., Ltd. (Flatness Tester FT-17) or Mitaka Kohki Co., Ltd.) or with a surface texture and contour integrated measuring instrument (for example, manufactured by Tokyo Seimitsu Co., Ltd.).

In the present invention, the improvement of warpage after chemical strengthening is evaluated by Δwarpage amount determined according to the following formula.

ΔWarpage amount=warpage amount after chemical strengthening-warpage amount before chemical strengthening

CS (surface compressive stress) and DOL (depth of compressive stress layer) of a glass sheet can be measured with a surface stress meter. It is well known that the warpage varies depending on the degree of chemical strengthening. For comparing the relative warpage, on the assumption that the warpage is proportional to the value of CS*DOL, the warpage can be compared by converting it to warpage when CS*DOL=8,000 (MPa·μm).

### Conversion Method:

Warpage amount (reduced value)=warpage amount (measured value)×8000/(CS (measured value)×DOL (measured value))

### EXAMPLES

Working examples of the present invention are described specifically below, but the present invention is not limited thereto.

### (Composition of Glass Sheet)

In this test example, a float glass was manufactured using a glass sheet of a glass material A having the following composition.

### (Glass Material A)

A glass containing, as represented by mass %, 68.5% of SiO₂, 5.0% of Al₂O₃, 14.7% of Na₂O, 0.2% of K₂O, 4.1% of MgO, and 7.2% of CaO.

Glass transition temperature (Tg): 556° C.

### (Na₂O Concentration)

The Na₂O concentration was measured by the above-described XRF (X-ray Fluorescence Spectrometry) method. The quantitative determination was performed by a calibration method using an Na₂O standard sample. Based on the measurement results, the above-described ΔNa₂O was determined.

(Average ¹H/³⁰Si Count, Fluorine Concentration)

The fluorine concentration and ¹H/³⁰Si count distributions in the thickness direction were measured using the above-described secondary ion mass spectroscopy (SIMS). Based on the measurement results, the above-described Δ¹H/³⁰Si, ΔF, and surface-layer fluorine ratio (F₀₋₃/F₀₋₃₀) were determined.

### (Tin Concentration)

The tin concentration was measured by the above-described XRF (X-ray Fluorescence Spectrometry) method. The quantitative determination was performed by a calibration method using a standard sample of SnO₂ in glass, and the value of Tin count as an indicator of tin content in glass was calculated. Based on the measurement results, the above-described ΔSn was determined.

### (CS and DOL)

CS and DOL were measured using a surface stress meter (FSM-6000LE) manufactured by Orihara Industrial Co., Ltd.

### (Measurement of Warpage Amount)

The warpage amount of glass was measured using Flatness Tester FT-17 (manufactured by NIDEK Co., Ltd.).

In the following test examples, Examples 1 to 8 are Examples of the present invention, and Examples 9 to 18 are Comparative Examples.

### Examples 1 to 4

In a float bath where a glass ribbon of the glass material A was flowing, a fluorine treatment of the top surface was conducted under the conditions shown below with an HF gas.

Example 1: HF gas 6 (vol %), treatment time 3.5 seconds, treatment temperature 830° C.

Example 2: HF gas 5 (vol %), treatment time 3.5 seconds, treatment temperature 830° C.

Example 3: HF gas 4 (vol %), treatment time 3.5 seconds, treatment temperature 830° C.

Example 4: HF gas 2 (vol %), treatment time 3.5 seconds, treatment temperature 830° C.

### Examples 5 to 8

In a float bath where a glass ribbon of the glass material A was flowing, a fluorine treatment of the top surface was conducted under the conditions shown below by using an HF gas and thereafter, a dealkalization treatment of the top surface was conducted under the conditions shown below by using SO₃ in a lehr.

Example 5: HF gas 6 (vol %), treatment time 3.5 seconds, treatment temperature 830° C.→in the lehr, SO₃ about 5 (vol %), spraying treatment in zone at a temperature of 500 to 550° C.

Example 6: HF gas 5 (vol %), treatment time 3.5 seconds, treatment temperature 830° C.→in the lehr, SO₃ about 5 (vol %), spraying treatment in zone at a temperature of 500 to 550° C.

Example 7: HF gas 4 (vol %), treatment time 3.5 seconds, treatment temperature 830° C.→in the lehr, SO₃ about 9 (vol %), spraying treatment in zone at a temperature of 500 to 550° C.

Example 8: HF gas 2 (vol %), treatment time 3.5 seconds, treatment temperature 830° C.→in the lehr, SO₃ about 7.5 (vol %), spraying treatment in region at a temperature of 500 to 550° C.

### Example 9

Example 9: The glass material A was manufactured without performing a fluorine treatment and a dealkalization treatment.

### Example 10

Example 10: Forming was performed by lowering the temperature during float forming by about 30° C. from the upstream of the float bath, compared with that at normal production.

### Examples 11 and 12

Example 11: The concentration of hydrogen charged into the float bath was increased to 10 vol %.

Example 12: The concentration of hydrogen charged into the float bath was decreased to 1 vol %.

### Examples 13 to 15

In a float bath where a glass ribbon of the glass material A was flowing, a dealkalization treatment of the top surface was conducted under the conditions shown below with a mixed gas of HF and HCl.

Example 13: HF:HCl=4:8 (vol %), treatment time 3.5 seconds, treatment temperature 752° C.

Example 14: HF:HCl=6:12 (vol %), treatment time 3.5 seconds, treatment temperature 752° C.

Example 15: HF:HCl=6:6 (vol %), treatment time 3.5 seconds, treatment temperature 752° C.

### Examples 16 to 18

In a float bath where a glass ribbon of the glass material A was flowing, a fluorine treatment of the top surface was conducted under the conditions shown below with an HF gas.

Example 16: HF gas 4 (vol %), treatment time 3.5 seconds, treatment temperature 725° C.

Example 17: HF gas 10 (vol %), treatment time 3.5 seconds, treatment temperature 830° C.

Example 18: HF gas 8 (vol %), treatment time 3.5 seconds, treatment temperature 830° C.

The glass having a sheet thickness of 0.7 mm obtained in each of test examples above was cut into three 100 mm-square sheets, and warpage in the portion corresponding to a 90 mm-square portion of the substrate was measured and taken as the warpage amount before strengthening. Thereafter, chemical strengthening was performed by immersing the glass in KNO₃ molten salt heated to 410° C. for 6 hours. Subsequently, warpage in a portion corresponding to a 90 mm-square portion of the substrate was measured and taken as the warpage amount after strengthening.

In addition, both surfaces of each glass before chemical strengthening were ground by 3 μm with a glass grinder and after performing the same chemical strengthening, the warpage was measured in the same manner.

From the measured values of respective warpage amounts, CS and DOL, the reduced value of the warpage amount was calculated based on the following formula and furthermore, the warpage dislocation amount (Δwarpage amount) represented by the following formula was calculated.

Warpage amount (reduced value)=warpage amount (measured value)×8000/(CS (measured value)×DOL (measured value))

ΔWarpage amount (non-ground)=warpage amount after chemical strengthening−warpage amount before chemical strengthening

ΔWarpage amount (after grinding)=warpage amount after grinding and chemical strengthening−warpage amount after grinding but before chemical strengthening

The tolerance of the warpage displacement amount (Δwarpage amount) was set to be ±40 μm for both non-ground and after grinding.

The results are shown in Table 1.

TABLE 1

| | | | | | | | | | ΔWarpage | ΔWarpage | | |
|---|---|---|---|---|---|---|---|---|---|---|---|---|
| | | | | | | | | | Amount | Amount (after | CS | DOL |
| | X | A*Δ¹H/³⁰Si | B*ΔNa₂O | C*ΔSn | D*ΔF | F₀₋₃ | F₀₋₃₀ | F₀₋₃/F₀₋₃₀ | (non-ground) | grinding) | (MPa) | (μm) |
| Example 1 | −0.06 | −0.32 | 0.11 | −0.17 | −0.66 | 0.92 | 2.00 | 0.46 | −8 | −2 | 709 | 12.4 |
| Example 2 | 0.10 | −0.38 | 0.08 | −0.17 | −0.53 | 0.72 | 1.73 | 0.42 | 12 | 15 | 714 | 12.3 |
| Example 3 | 0.06 | −0.35 | 0.03 | −0.16 | −0.48 | 0.51 | 1.12 | 0.46 | 8 | 19 | 716 | 12.2 |
| Example 4 | 0.28 | −0.36 | 0.05 | −0.16 | −0.29 | 0.29 | 0.69 | 0.42 | 35 | 32 | 718 | 12.3 |
| Example 5 | −0.26 | −0.21 | −0.10 | −0.17 | −0.53 | 0.72 | 1.73 | 0.42 | −32 | −7 | 698 | 12.4 |
| Example 6 | −0.28 | −0.34 | −0.08 | −0.12 | −0.66 | 0.92 | 2.00 | 0.46 | −34 | 9 | 694 | 12.5 |
| Example 7 | −0.22 | −0.23 | −0.20 | −0.22 | −0.48 | 0.51 | 1.12 | 0.46 | −28 | 10 | 683 | 12.2 |
| Example 8 | 0.07 | −0.31 | −0.15 | −0.20 | −0.29 | 0.29 | 0.69 | 0.42 | 9 | 25 | 714 | 12.3 |
| Example 9 | 0.81 | −0.37 | 0.28 | −0.16 | −0.0043 | 0.01 | 0.04 | 0.18 | 100 | 44 | 745 | 12.6 |
| Example 10 | 0.69 | −0.21 | 0.33 | −0.16 | −0.0043 | 0.01 | 0.04 | 0.18 | 86 | 24 | 742 | 12.6 |
| Example 11 | 0.74 | −0.34 | 0.28 | −0.12 | −0.0043 | 0.01 | 0.04 | 0.18 | 91 | 40 | 746 | 12.2 |
| Example 12 | 0.85 | −0.35 | 0.28 | −0.22 | −0.0043 | 0.01 | 0.04 | 0.18 | 104 | 43 | 748 | 12.5 |
| Example 13 | −0.10 | −0.35 | −0.60 | −0.16 | −0.0043 | 0.01 | 0.04 | 0.18 | −12 | 45 | 703 | 12.3 |
| Example 14 | −0.43 | −0.34 | −0.93 | −0.17 | −0.0043 | 0.01 | 0.04 | 0.18 | −53 | 18 | 686 | 11.9 |
| Example 15 | −0.30 | −0.30 | −0.78 | −0.19 | −0.0043 | 0.01 | 0.04 | 0.18 | −37 | 45 | 693 | 12.1 |
| Example 16 | 0.29 | −0.37 | 0.21 | −0.21 | −0.50 | 1.00 | 1.10 | 0.90 | 36 | 49 | 709 | 12.2 |
| Example 17 | −0.91 | −0.35 | 0.15 | −0.17 | −1.57 | 1.44 | 3.62 | 0.40 | −113 | −67 | 668 | 11.6 |
| Example 18 | −0.55 | −0.34 | 0.10 | −0.16 | −1.15 | 1.16 | 2.77 | 0.42 | −68 | −16 | 684 | 11.7 |

As seen in Table 1, in the glass sheets of Examples where X and F₀₋₃ are within the scope of the present invention, the warpage after chemical strengthening was effectively improved in both cases when not ground and when ground.

While the invention has been described in detail and with reference to specific embodiments thereof, it will be apparent to one skilled in the art that various changes and modifications can be made therein without departing from the spirit and scope of the invention. This application is based on a Japanese Patent Application No. 2015-063309 filed on Mar. 25, 2015, the entirety of which is incorporated herein by way of reference. In addition, all references cited herein are incorporated in their entirety.

### DESCRIPTION OF REFERENCE NUMERALS AND SIGNS

1 Center slit
2 Outer slit
4 Channel
5 Discharge slit
20 Glass sheet
101 Glass ribbon
102 Beam
103 Radiation gate
110 Width direction of glass ribbon
111, 112, 113 Gas system
114, 115 Partition wall
116 Gas blowing hole

1. A glass sheet comprising a first main surface and a second main surface opposite to the first main surface in a thickness direction, wherein
X represented by the following formula (1) is −0.29<X<0.29; and
F₀₋₃ determined according to the following formula (II) is 0.02 or more:
A×Δ¹H/³⁰Si+B×ΔNa₂O+C×ΔSn+D×ΔF=X (1)
wherein in the formula (1), each parameter has the following meaning:
A¹H/³⁰Si: a value of difference obtained by subtracting an average count by secondary ion mass spectroscopy (SIMS) at a depth of 3 to 12 μm in the second main surface from an average ¹H/³⁰Si count by SIMS at a depth of 3 to 12 μm in the first main surface;
ΔNa₂O: a value of difference obtained by subtracting an average Na₂O concentration (wt %) by XRF at a depth of 0 to 3 μm in the second main surface from an average Na₂O concentration (wt %) by XRF at a depth of 0 to 3 μm in the first main surface;
ΔSn: a value of difference obtained by subtracting Tin count as an indicator of tin content in a glass by XRF at a depth of 0 to 10 μm in the second main surface from the value of Tin count as an indicator of tin content in a glass by XRF at a depth of 0 to 10 μm in the first main surface;
ΔF: a value of difference obtained by subtracting an average fluorine concentration (wt %) by SIMS×12 at a depth of 0 to 12 μm in the second main surface from an average fluorine concentration (wt %) by SIMS×12 at a depth of 0 to 12 μm in the first main surface;
A: −128.95;
B: 1;
C: −0.0002428; and
D: −0.009922:
and
F₀₋₃=[average fluorine concentration by SIMS at depth of 0 to 3 μm in first main surface]×3 (II).

2. The glass sheet according to claim 1, wherein a surface layer fluorine ratio represented by the following formula (I) is 0.2 or more and less than 0.9:
surface-layer fluorine ratio=F₀₋₃/F₀₋₃₀ (I)
wherein in the formula (I), F₀₋₃ is determined according to the following formula (H);
F₀₋₃=[average fluorine concentration (wt %) by SIMS at depth of 0 to 3 μm in first main surface]×3 (II)
and
in formula (1), F₀₋₃₀ is determined according to the following formula (III);
F₀₋₃₀=[average fluorine concentration (wt %) by SIMS at depth of 0 to 30 μm in first main surface]×30 (III).

3. The glass sheet according to claim 1, which is a glass sheet produced by a float process.

4. A chemically strengthened glass sheet obtained by chemically strengthening the glass sheet according to claim 1.
